(19) United States
(12) Patent Application Publication
(10) Pub. No.: US 2013/0061814 A1
(43) Pub. Date: Mar. 14, 2013

(54) ANIMAL COLLAR

(71) Applicant: Philip Kelvin Crisp, Blackwood (GB)

(72) Inventor: Philip Kelvin Crisp, Blackwood (GB)

(21) Appl. No.: 13/602,984

(22) Filed: Sep. 4, 2012

Related U.S. Application Data
(62) Division of application No. 12/673,353, filed on Feb. 12, 2010, now abandoned.

(30) Foreign Application Priority Data
Aug. 17, 2007 (GB) 0716105.2
Mar. 6, 2008 (GB) 0804153.5

(51) Int. Cl. A01K 27/00; A01K 13/00

(52) U.S. Cl. 119/654; 119/850; 119/858

(57) ABSTRACT

A pet safety collar especially for cats includes an elongate resilient flexible cord element formed into a coil having a plurality of randomly over-lapping turns, the ends of the element being free. In use, the coils can be opened to allow the collar to be fitted around the neck of an animal, whereupon the collar recovers its shape. In the event that the collar becomes trapped, the coil expands allowing the animal to be freed.

### CROSS-REFERENCE TO PRIOR APPLICATION

This is a division of application Ser. No. 12/673,353, filed Feb. 12, 2010, which represents the U.S. National Phase application of P.C.T. Application No. PCT/EP2008/060785, filed Aug. 18, 2008.

### BACKGROUND OF THE INVENTION

1. Technical Field of the Invention

This invention relates to an animal collar.

2. Description of the Prior Art

It is well known to fit the collars to domestic animals so that a lead or leash can be attached thereto. Also, collars enable the animals to be provided with identity tags.

Typically, known collars comprise an elongate strap which can be fastened end-to-end round the neck of the animal. A disadvantage of this is that the collar can become tight around the animals neck if the animal grows. Furthermore, the collar can become entangled with objects such as bushes, trees and fences, with the result that the animal may become trapped or strangled. This is a particular problem with cats who have a tendency to climb and force themselves into confined spaces.

Cat collars are known which have an expandable section, which allows the collar to expand when it becomes trapped. Another known cat collar comprises a fastening which releases under a pre-determined load. The aforementioned cat collar suffers from the disadvantage that the degree of expansion is insufficient to prevent strangulation. A disadvantage of the latter is that the fastening can inadvertently release, with the result that the collar becomes lost.

I have now devised an animal collar which alleviates the above-mentioned problems.

### SUMMARY OF THE INVENTION

In accordance with the present invention, there is provided an animal collar comprising an elongate resilient flexible element formed into a coil comprising a plurality of over-lapping turns, the ends of the element being free.

In use, the coils can be opened to allow the collar to be fitted around the neck of an animal, whereupon the collar recovers it shape. In the event that the collar becomes trapped, the coil expands allowing the animal to be freed.

Preferably the elongate resiliently flexible element comprises nylon or other plastics material which is cheap to manufacture.

Preferably the elongate resiliently flexible element comprises a cord or other filament arranged to coil loosely and randomly around an animal's neck. In order to achieve this, the maximum cross-sectional dimension of the cord or other filament is preferably no more than double the minimum cross-sectional dimension. Preferably the dimensions are substantially equal and preferably the cord or filament is circular in cross-section.

The elongate resiliently flexible element maybe contained within a tubular sleeve, for example, formed of a braided material. The sleeve maybe impregnated or otherwise treated with an insecticide or another compound which treats the animal. In an alternative embodiment, the elongate resiliently flexible element may extend through beads or tubes, which may extend end-to-end of the element.

Preferably the elongate element is provided with means such as beads or eyelets or other formations to which a lead can be attached. Preferably said means comprises at least two formations disposed at spaced apart locations on the elongate element which can be brought and held together when a lead is attached, so as to prevent expansion of the coils and to alleviate the risk that an animal may escape from the lead by pulling on the collar. At least one of the formations may be provided on an end of the elongate element.

Preferably means are provided intermediate opposite ends of the resiliently flexible elongate element for attaching the collar to an identity tag or disc or to another device, such as a bell.

Preferably the coil comprises at least 2 turns and preferably less than 3 turns, so that the collar has to unwind to come off yet is still able to detach readily.

### BRIEF DESCRIPTION OF THE DRAWING FIGURES

An embodiment of the present invention will now be described by way of example only and with reference to the accompanying drawings, in which:

FIG. 1 is a front view of a pet collar in accordance with the present invention;

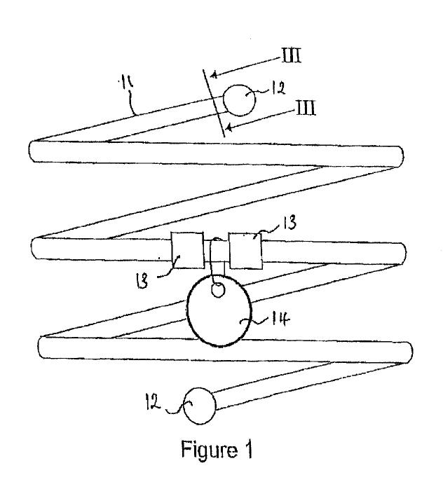

FIG. 2 is a planned view of the collar of FIG. 1; and

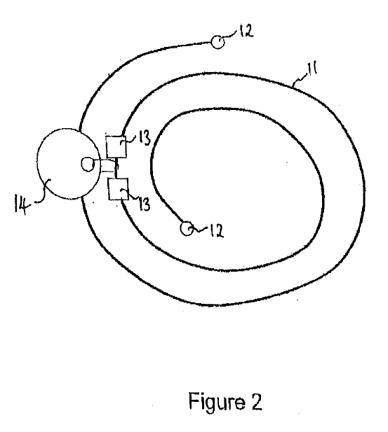

FIG. 3 is a sectional view along the line of FIG. 1.

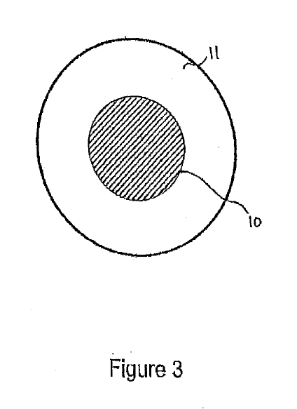

### DETAILED DESCRIPTION OF THE DRAWING FIGURES AND PREFERRED EMBODIMENTS

Referring to the drawings, there is shown a pet collar comprising an elongate resiliently flexible cord 10 of nylon or other plastics material which is formed into a coil comprising at least two overlapping turns. The cord 10 is contained within a braided sleeve 11, which maybe multi-coloured and treated with an insecticide or pharmaceutical product.

The opposite ends of the cord 10 are fitted with beads 12 in order to protect the sharp ends. A pair of beads 13 are fitted intermediate opposite ends of the elongate cord 10, the beads 13 being spaced apart to define a region around which the eyelet of an identity tag 14 maybe fastened. Alternatively, a bell or other device maybe fitted to this region in a similar manner.

In use, the coil is opened to allow it to be passed over the head of an animal, whereupon the coil is allowed to recover its shape so that it is firmly held in-situ. The turns of the coil randomly overlap axially and/or radially of each other with respect to the axis about which the collar is coiled. In the event that the collar becomes trapped, the coils can expand and unwind to allow the animal to free itself.

In an alternative embodiment, one or more of the end beads 12 maybe replaced by eyelets, which allow the collar to be connected to a lead. Preferably, the elongate element is formed into coils which are circular in plan as shown in the drawings. However, it will be appreciated that the coils could be of any suitable shape.

A collar in accordance with the present invention is simple and inexpensive in construction, yet is aesthetically pleasing and alleviates any risk of the animal being injured when the collar becomes trapped.

1-20. (canceled)

21. A method for providing a domesticated animal with an animal collar, comprising the step of:
placing an elongate resiliently flexible element formed into a coil around a neck of a domesticated animal, said elongate resiliently flexible element comprising a plurality of overlapping turns with ends of said elongate resiliently flexible element being free.

22. The method for providing a domesticated animal an animal collar according to claim 21, wherein said elongate resiliently flexible element is made of a plastic material.

23. The method for providing a domesticated animal an animal collar according to claim 21, wherein said elongate resiliently flexible element is made of nylon.

24. The method for providing a domesticated animal an animal collar according to claim 21, wherein said elongate resiliently flexible element is contained within a tubular sleeve.

25. The method for providing a domesticated animal an animal collar according to claim 24, wherein said tubular sleeve is formed of a braided material.

26. The method for providing a domesticated animal an animal collar according to claim 25, wherein said tubular sleeve is treated with an insecticide for treating said domesticated animal.

27. The method for providing a domesticated animal an animal collar according to claim 21, wherein said elongate resiliently flexible element extends through beads or tubes.

28. The method for providing a domesticated animal an animal collar according to claim 27, wherein said beads or tubes extend end-to-end of said elongate resiliently flexible element.

29. The method for providing a domesticated animal an animal collar according to claim 21, wherein said elongate resiliently flexible element includes means for attaching a lead thereto.

30. The method for providing a domesticated animal an animal collar according to claim 29, wherein said means for attaching a lead includes a plurality of formations disposed at spaced apart locations on said elongate resiliently flexible element.

31. The method for providing a domesticated animal an animal collar according to claim 30, wherein at least one formation of said plurality of formations is provided on an end of said elongate resiliently flexible element.

32. The method for providing a domesticated animal an animal collar according to claim 30, wherein said plurality of formation comprise beads.

33. The method for providing a domesticated animal an animal collar according to claim 30, wherein said plurality of formation comprise eyelets.

34. The method for providing a domesticated animal an animal collar according to claim 21, further comprising means for attaching a collar provided intermediate opposite ends of said elongate resiliently flexible element.

35. The method for providing a domesticated animal an animal collar according to claim 21, wherein said coil comprises at least two turns.

36. The method for providing a domesticated animal an animal collar according to claim 35, wherein said coil comprises less than three turns.

37. The method for providing a domesticated animal an animal collar according to claim 21, wherein said elongate resiliently flexible element includes a cord to coil loosely and randomly around a neck of said domesticated animal.

38. The animal collar in combination with a domesticated animal according to claim 21, wherein said coil has turns which randomly overlap axially or radially of each other relative to an axis about which said elongate resiliently flexible element is coiled.

39. A method for providing a domesticated animal with an animal collar, comprising the steps of:
forming a coil from an elongated resiliently flexible element, said coil including at least two freely overlapping turns and two free ends and enlarged end elements disposed at said two free ends;
placing said coil around a neck of a domesticated animal;
providing an attachment loop interposed on said coil between said two free ends for connecting to a bell or tag; and,
disposing two beads on said coil in a spaced-apart relationship and flanking the bell or tag.

40. The method for providing a domesticated animal with an animal according to claim 39, wherein said coil has turns which randomly overlap axially or radially of each other relative to an axis about which said elongate resiliently flexible element is coiled.
